(19) United States
(12) Patent Application Publication
(10) Pub. No.: US 2026/0363262 A1
(43) Pub. Date: Nov. 19, 2026

(54) POLYUNSATURATED FATTY ACID-ENRICHED OIL COMPOSITION

(71) Applicant: POLARIS, QUIMPER (FR)

(72) Inventors: Gildas Breton, Loctudy (FR); Julie Jourdren, Kernével (FR); Lionel Larvol, Pluguffan (FR)

(21) Appl. No.: 19/478,348

(22) PCT Filed: Apr. 24, 2024
(86) PCT No.: PCT/EP2024/061278

§ 371 Date: Nov. 10, 2025

(30) Foreign Application Priority Data
Apr. 24, 2023 (FR) 2304115

(51) Int. Cl. A23D 7/005; A23C 9/13; A23C 9/152; A23D 7/01; A23L 29/00

(52) U.S. Cl. CPC A23D 7/0053; A23C 9/1315; A23C 9/1528; A23D 7/011; A23L 29/04

(57) ABSTRACT

A polyunsaturated fatty acid-enriched oil composition comprises an emulsion of a source of polyunsaturated fatty acids in the form of majority triglycerides and a stabilizing agent, wherein the oil composition comprises at least one natural chelating agent.

### CROSS-REFERENCE TO RELATED APPLICATIONS

This application is a national phase entry under 35 U.S.C. § 371 of International Patent Application PCT/EP2024/061278, filed Apr. 24, 2024, designating the United States of America and published as International Patent Publication WO 2024/223681 A1 on Oct. 31, 2024, which claims the benefit under Article 8 of the Patent Cooperation Treaty of French Patent Application Serial No. FR2304115, filed Apr. 24, 2023.

### TECHNICAL FIELD

The present disclosure relates to the field of highly unsaturated oils and notably polyunsaturated fatty acid-enriched oil compositions, notably in the form of stable emulsions suitable for incorporation into foodstuffs or dermo-cosmetics. These oils are notably fish oils, algae oils or vegetable oils. They are obtained by a cold-press extraction method.

### BACKGROUND

Highly unsaturated oils are very sensitive to oxidation induced by the presence of oxygen, heat, metals, water, etc. It is therefore essential to protect them against oxidation to preserve their nutritional and organoleptic qualities and their shelf life.

Docosahexaenoic acid (DHA), for example, is subject to a natural process of oxidative lipid degradation that occurs when an unsaturated lipid is in the presence of oxygen or light. To counteract this degradation process and to preserve the beneficial effects of DHA, a method for stabilizing oils rich in polyunsaturated fatty acids against oxidation has already been developed by the applicant. This method combines the destruction of lipoxygenases present in the oil with the addition of antioxidant compounds to preserve the nutritional and organoleptic qualities of the oil and delay the onset of oxidation. The comparison of induction times (the time after which oxidation reactions begin to propagate) assessed using the Rancimat method, shows that oils that have undergone this method, known under the brand name “QUALITYSILVER©,” are 2 to 7 times more stable than standard oils containing a natural mix of antioxidants (tocopherols).

In the state of the art, European Patent Application EP1905425 relates to vesicles, which comprise a hydrophobic inner cavity essentially free of organic solvent and at least one bilayer consisting of two layers of amphiphilic lipids defining a hydrophilic interstitial space therebetween. The aim is to form uni- or multivesicular structures and not emulsions. This document does not disclose a composition consisting of an emulsion, and not a liposomal composition. In this solution, there is no chelation reaction, since the compound of interest is protected by the fatty phase formed by the lipid bilayers.

U.S. Patent Application Publication No. 2011/105433 A1 relates to the prevention and/or the inhibition of the generation of off-flavors in food products. In particular, the invention relates to the formulation of mixtures of lipid raw materials and of food products containing long-chain polyunsaturated fatty acids, and to compositions and methods for stabilizing these products against the formation of off-flavors, such as off-flavors in fish. This patent application notably proposes a composition containing an LC-PUFA containing oil and lecithin, the weight ratio of lecithin to LC-PUFA being at least about 25:75. It notably proposes a composition that contains an LC-PUFA containing oil and lecithin, the weight ratio of lecithin to LC-PUFA being at least about 25:75.

This document does not relate to emulsions but etherogenic fatty acids

U.S. Patent Application Publication No. 2013/059768 A1 discloses lipid compositions comprising phospholipids having a high docosahexaenoic acid (DHA) content, these compositions preferably being extracted from natural sources. Lipid compositions are excellent sources of highly bioavailable DHA and can be used in oral vectors, dietary supplements, functional foods, etc.

U.S. Patent Application Publication No. 2007/298083 A1 discloses a stable aqueous emulsion containing water, a mixture of esters containing esters of polyunsaturated fatty acids, such as omega-3 fatty acids, emulsifiers and stabilizers. The emulsion can be used as a beverage or as an additive that can be added to a beverage or to a food product. The emulsion provides available and stable omega-3 fatty acids with no undesirable rancid odor.

U.S. Patent Application Publication No. 2016/345618 A1 relates to an aqueous omega-3 fatty acid composition comprising: a) water; b) a high HLB non-ionic emulsifier with HLB>10; and c) a marine oil, an algal-derived oil or a vegetable oil rich in omega-3 fatty acid and comprising a total of glycerides having a monoglyceride (MG), a diglyceride (DG) and a triglyceride (TG) of the omega-3 fatty acid, the TG of the omega-3 fatty acid content in the composition being less than 80% of the total of glycerides.

The emulsions prepared in this way according to the solutions of the background art and notably according to the Qualitysilver™ method are generally satisfactory. However, when they are then added to food or dermo-cosmetic products whose preparation requires a step where they are subjected to a high temperature (typically around 120°) and/or prolonged (typically more than 60 seconds), degradation is observed resulting in organoleptic qualities that are difficult to accept for quality products.

The problem of oxidation of additives according to the state of the art also arises when they are added to certain types of food containing iron, for example, dairy products or when water is added, which results in the addition of minerals that can lead to a degradation of the state of the art solutions and a rancidity phenomenon.

### BRIEF SUMMARY

The present disclosure aims to address these drawbacks. To this end, the present disclosure relates to a polyunsaturated fatty acid-enriched oil composition.

The composition consists of an emulsion of a source of polyunsaturated fatty acids in the form of majority triglycerides and a stabilizing agent, characterized in that the oil composition comprises a natural chelating agent.

The object of the present disclosure may also have one or a compatible combination of the following features.

The oil composition comprises:
99.5% glycerol;
DHA-rich algae oil; more generally, a DHA-rich oil from micro-organisms or micro-algae;
Sucroesters and/or lysophosphatidylcholine and/or lecithin;
Chelating agent.

Advantageously, the composition further comprises DPAn-6 and its content is between 0.1% and 20% by weight with respect to the total weight of the oil in the composition. DPAn-6 stands for omega-3 docosapentaenoic acid or Osbond acid/C22:5 n-6.

According to a particular embodiment, the algae oil confers a concentration greater than 50 mg of DHA and/or EPA per gram of emulsion.

Advantageously, the chelating agent consists at least in part of citric acid and/or tartaric acid, preferably solubilized in glycerol, in the presence of phospholipids.

According to another variant, the chelating agent consists of a phosphatidylcholine.

According to another variant, the chelating agent consists of a lysophosphatidylcholine.

According to another variant, the chelating agent consists of ascorbic acid.

According to another variant, the chelating agent consists of polyphenols, e.g., green tea.

Advantageously, the composition is formed of lipid globules surrounded by Lyso PC molecules.

The present disclosure also relates to an omega-3 enriched food with a composition in accordance with one of the preceding claims.

### BRIEF DESCRIPTION OF THE DRAWINGS

The present disclosure will be better understood from reading the following description, which relates to a non-limiting exemplary embodiment illustrated by the accompanying drawings, in which:

FIG. 1 shows a schematic view of the skin of a lipid droplet obtained by the method according to the present disclosure.

### DETAILED DESCRIPTION

The aim of the present disclosure is to propose additives for enriching with polyunsaturated fatty acids food or dermo-cosmetic products resistant to intermediate treatments at high temperatures, by a composition and, in particular, a pre-emulsion prepared in accordance with the method of the background art, with an addition of a chelating agent, notably a phosphatidylcholine, optionally in a form derived from lysophosphatidylcholine or citric acid solubilized in glycerol.

The result of the present disclosure is strengthening of the micellar membrane surrounding the DHA-containing oil phase, which has several advantages:

Firstly, this strengthening reduces degradation of the DHA-containing oil, and thus avoids the rancidity observed with the solutions of the background art.

The presence of a chelating agent at the membrane-oil interface reduces oil degradation and the resulting sensation of rancidity.

Finally, the strengthening and the structure of this membrane slows down its destruction during digestion of the enriched product and when passing through stomach barriers, which improves the availability of the DHA at plasma and lymphatic levels.

The lymphatic bioavailability study investigating the overall absorption of DHA expressed as mg/mL*h of DHA in rats subjected to lymphatic duct fistulation (n=6 rats/group) and given an equivalent of 300 mg of DHA over a 6-hour period shows that this absorption is significantly higher for DHA pre-emulsion (24 mg/mL*h) than for the same oil making up this emulsion (17 mg/mL*h).

### First Preparation Example

The first preparation example relates to a composition comprising a sucroester alone or combined with lysophosphatidylcholine (Lyso-PC).

The first step consists of preparing a polar phase by mixing a proportion of 60% glycerol and 4% sucroester; and of heating this preparation at a temperature of 80° until the mixture reaches this temperature. This step is advantageously carried out in a vacuum reactor or in a nitrogen atmosphere.

At the same time, an apolar oil phase containing DHA and a chelating agent, for example, lysophosphatidylcholine, is prepared by heating it to a temperature of 80 °C in the absence of air, for example, in a vacuum or nitrogen atmosphere.

Alternatively, depending on its water-soluble nature, the chelating agent may be introduced into the polar phase, whereas it will be introduced into the apolar phase when it is liposoluble, or indifferently in amphiphilic media.

The polar phase is then introduced into the reactor in a vacuum or nitrogen atmosphere containing the apolar phase at 80 °C by gradual incorporation and stirring with a rotor-stator emulsion mixer to obtain a homogeneous product. For example, a 3.6 kg mixture is stirred for a period of 10 minutes at a speed of 10,000 to 15,000 rpm. The reactor is maintained at a temperature of 80 °C during this emulsification step.

The rotor-stator is then stopped, keeping the mixer active, and, in the case of a vacuum reactor, nitrogen is introduced to re-establish atmospheric pressure and prevent the introduction of oxygen into the reactor.

The emulsion thus prepared is then removed and packaged in an opaque container under an inert atmosphere.

When the composition thus prepared is introduced into water, a homogeneous dispersion of stable micelles is obtained, with the DHA-rich oil phase encapsulated in a membrane formed by the phospholipid, on the order of 0.4 μm in diameter.

This composition remains stable even when the product wherein it is found is in the presence of iron, the phospholipid membrane remaining closed and limiting the migration of the oily phase. The chelating agent introduced during the preparation of the composition will be found at the interface between the membrane and the oily core containing the DHA, and will chelate the iron preventing it from penetrating the oil phase.

When the chelating agent is formed by lysophosphatidylcholine, the membrane is strengthened, giving micelles greater shell stability and improved resistance in the event of heating of the product, thereby delaying the phenomenon of rancidity due to denaturation of the oil phase.

Composition with Sucroester-Free Lysophosphatidylcholine

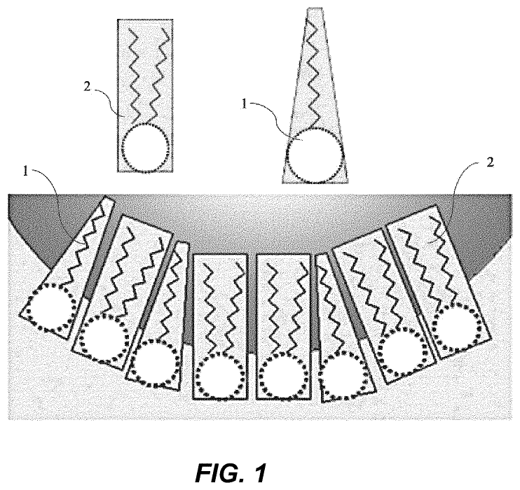

One embodiment consists of preparing a polar and/or apolar phase containing lysophosphatidylcholine (1) alone or in a mixture with phosphatidylcholine (2) or, more broadly, lecithin. The rest of the method remains unchanged. The droplets obtained according to this variant have a skin exemplified in FIG. 1.

The use of lysophosphatidylcholine, that is with one less hydrophobic tail, enables lipid droplets to be closed more effectively by optimizing curvature.

This variant is more resistant to acidic food preparation applications, for example, beverages that are generally acidic (fruit juices, syrups, etc.).

Furthermore, the use of lysoPC enables the formation of smaller particles, even without the use of pressure during emulsion production (often at over 400 bar, or even 1000 bar).

The size of the emulsion particles corresponds to a particle size of about 0.2 μm with lysoPC as emulsifier (emulsion produced in the vacuum reactor). The reduced size of the lipid droplets increases the contact surface. This runs counter to the oxidative stabilization effect sought, but oil droplets are better closed with lysoPC and more stable (no coalescence).

With lysoPC, the addition of additional surfactant for emulsion stabilization is not necessary.

Preparation Example of a Food Enriched with Omega 3

The above-mentioned composition is intended, for example, for the preparation of a syrup enriched with omega 3. The method consists of adding 10% of DHA-containing emulsion to a syrup, which contains citric acid to reinforce the chelating action of the composition according to the present disclosure.

The oxidation of lipids is greater at acid pH. The addition of citric acid has a chelating effect on metals (iron) and reinforces the chelating effect of phospholipids.

Preparation Example of a Food Enriched with Omega 3

Another example of application relates to the preparation of omega-3 enriched milk; the above-mentioned composition is added to milk at room temperature. The micelles disperse and intercalate between the casein micelles in the milk, without the oily phase rising to the surface.

### Nature of Enriched Oils

The method and the composition is applicable to various types of natural microalgae oils containing about 40% DHA, or enriched, notably with DHA, and/or EPA.

Preparation of a DHA-enriched yogurt:

The following example relates to the preparation of a DHA-enriched yogurt according to the present disclosure.

The preparation method comprises the following steps:
a) Bring 1 L of whole cow's milk to the boil (this recipe can also be adapted with plant milks and appropriate texturizers);
b) Allow the milk to cool to 50 °C;
c) Add 12.5 g of emulsion containing 160 mg/g of DHA (the emulsion content and the percentage added can be adapted according to the desired content per yogurt);
d) Homogenize the mixture;
e) Add a sachet of commercial lactic ferments (at a temperature of about 45 °C);
f) Homogenize the mixture;
g) Divide 125 g of preparation per yogurt pot; and
h) Start yogurt fermentation in a conventional yogurt maker, 12 hour fermentation cycle.

At the end of the cycle, the yogurts are placed in the refrigerator for at least 4 hours before tasting.

Preparation of a DHA-enriched syrup:
Another example implementation of the present disclosure relates to the preparation of a DHA-enriched syrup. The initial syrup can be prepared from various sugar bases, for example:

Sucrose incorporated in water at 70 °C to obtain a 55% brix clear final solution; and

Agave syrup diluted directly with cold water to obtain a brix of 55%.

To obtain 1 L of syrup containing 20 mg/g of DHA, add 130 g of emulsion containing 160 mg/g of DHA and citric acid for the chelating action. The emulsion content and the percentage added can be adapted according to the desired syrup content. The emulsion is then solubilized in the syrup by gentle homogenization then stored at 4 °C in an inert atmosphere.

### Green Tea Extract

Another example implementation of the present disclosure relates to the preparation of a green tea extract (rich in polyphenols) that binds to the interface of the lipid particle.

The composition is as follows:

Emulsion base with Lysophosphatidylcholine emulsifier

| | |
|---|---|
| Glycerol | 55% |
| DHA 750 TG | 41% |
| LysoPC (unpurified) | 3.50% |

The stability time is analyzed with a Rancimat™ bench by adding iron to the emulsion to mimic the foods likely to be enriched with the DHA emulsion and to study the chelating effect of the antioxidants tested alone or in synergy.

The stability time in the presence of iron (300 μM fe2+) is 5.3H for a control sample (without treatment according to the present disclosure).

With an emulsion according to the present disclosure containing 0.057% fat-soluble catechins, the stability time increases significantly to 11.4H, including in the presence of iron.

With an emulsion according to the present disclosure containing 0.057% fat-soluble catechins+0.5% citric acid, the stability time increases significantly to 15.1H.

The addition of citric acid 0.5% or else green tea extract 0.2% or ascorbyl palmitate 0.45% doubles the stability time (about 11 hours) thus demonstrating their chelating effects.

The combination of citric acid 0.5%+ascorbyl palmitate 0.45% has a synergistic effect strengthening the chelating effect with a stability time of 18 hours despite the presence of iron.

### Other Variants

In order to improve encapsulation (in two phases), a variant consists of preparing a primary emulsion from glycerol+sucrose+oil to obtain stable globules, then stabilizing these globules by adding lecithins in a second step, also at ultra turrax in order to obtain better oxidative stability in food matrix).

1. A polyunsaturated fatty acid-enriched oil composition, comprising an emulsion of a source of polyunsaturated fatty acids in the form of majority triglycerides and at least one stabilizing agent, wherein the oil composition comprises at least one natural chelating agent.

2. The composition of claim 1, further comprising DPAn-6 at a content between 0.1% and 20% by weight with respect to the total weight of the oil in the composition.

3. The composition of claim 2, wherein the composition has the following formulation:
Glycerol;
Micro-organism oil rich in DHA and/or EPA;
Sucroesters and/or lysophosphatidylcholine and/or lecithin; and
Chelating agent.

4. The composition of claim 3, wherein algae oil confers a concentration greater than 50 mg of DHA and/or EPA per gram of emulsion.

5. The composition of claim 1, wherein the chelating agent comprises citric acid.

6. The composition of claim 1, wherein the chelating agent comprises tartaric acid.

7. The composition of claim 1, wherein the chelating agent comprises a phosphatidylcholine.

8. The composition of claim 1, wherein the chelating agent comprises a lysophosphatidylcholine.

9. The composition of claim 1, wherein the chelating agent comprises ascorbic acid.

10. The composition of claim 1, wherein the chelating agent comprises polyphenols.

11. The composition of claim 1, wherein polyphenols are extracted from green tea.

12. The composition of claim 1, wherein the chelating agent comprises ascorbyl palmitate.

13. The composition of claim 1, wherein the composition includes lipid globules surrounded by Lyso PC molecules.

14. The composition of claim 1, wherein the chelating agent comprises phytic acid.

15. The composition of claim 1, further comprising an emulsifying agent comprising citric acid mono-diglycerides.

16. An omega-3 enriched food or food supplement comprising a food including a composition according to claim 1.

17. The composition of claim 2, wherein the composition has the following formulation:
Glycerol;
Micro-organism oil rich in DHA and/or EPA;
Sucroesters and/or lysophosphatidylcholine and/or lecithin; and
Chelating agent.

18. The composition of claim 17, wherein algae oil confers a concentration greater than 50 mg of DHA and/or EPA per gram of emulsion.
